(19) United States
(12) Patent Application Publication
(10) Pub. No.: US 2011/0042446 A1
(43) Pub. Date: Feb. 24, 2011

(54) CONNECTION PART FOR DRAWER RAIL AND METHOD FOR WELDING THE CONNECTION PART TO THE DRAWER RAIL

(75) Inventors: Hsiu-Chiang LIANG, Kaohsiung Hsien (TW); Ken-Ching CHEN, Kaohsiung Hsien (TW); Chun-Chiang WANG, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(73) Assignee: KING SLIDE WORKS CO., LTD., Kaohsiung Hsien (TW)

(21) Appl. No.: 12/544,373

(22) Filed: Aug. 20, 2009

(51) Int. Cl. B23K 28/00; A47B 88/04

(52) U.S. Cl. 228/196; 312/334.1

(57) ABSTRACT

A connection part of a rail includes a head, a shank extending from an underside of the head and a ridge extending continuously from a top of the head. The ridge encloses a recess in the top of the head. The rail and the connection part are made of metal. The ridge contacts an attaching face of the rail, and a portion of the recess faces the attaching face. By means of welding, the ridge and the attaching face of the rail are melted to form a molten area which connects the connection part and the rail when being cooled.

### FIELD OF THE INVENTION

The present invention relates to a connection part for being connected with a drawer rail and a method for welding the connection part to the drawer rail by means of spot welding.

### BACKGROUND OF THE INVENTION

A conventional connection for welding a part to a rail is disclosed in U.S. Pat. No. 6,244,679, titled “Embosses and Method of Using same for Attachment of Members” to Robertson et al, which comprises a plurality of members and each member has at least one attaching face for attaching the member to another member such that the respective attaching faces of the attached members substantially abut. An emboss protrudes from an attaching face of a member of the plurality for attaching the member to another member from the plurality such that the emboss contacts the attaching face of another member, while providing a gap between the members. The plurality of members includes a first slide coupling member and a second slide coupling member. The first coupling member includes an emboss protruding from its attaching face and abutting the attaching face of the second coupling member. A gap is defined between the first and second coupling members. The second coupling member includes at least one emboss protruding from its attaching face. The disclosure discloses the use of spot welding to connect two members of similar shape, but is silent to the connection between two members of different shapes such as a flat board and a circular and cylindrical rod.

Generally, the spot welding applies a sufficient electric current to metal material and a resistance of the metal material generates high temperature to form a molten pool which becomes a welding spot after the molten pool is cooled. When the non-planar metal part such as a cylindrical part is connected with a metal flat board by means of spot welding, the curved surface of the cylindrical part contacts the board by a line and only limited spots are welded therebetween. The area of the molten pool is so small that the connection is not strong and reliable.

### SUMMARY OF THE INVENTION

The present invention relates to a connection part which includes a head, a shank extending from an underside of the head and a ridge extending continuously from a top of the head and enclosing a recess in the top of the head. The rail includes an attaching face and the ridge of the connection part contacts the attaching face. A portion of the recess faces the attaching face, and the ridge and the attaching face of the rail are melted to form a molten area which connects the connection part and the rail when being cooled.

The rail includes a pair of spaced upright walls and a transverse wall connected between two respective top ends of the pair of upright walls. A space is defined between the pair of upright walls and the transverse wall. A pair of lip portions extends from two respective lower ends of the pair of upright walls and toward the space. Each lip portion includes a planar surface.

The ridge of the connection part extends continuously along a periphery of the head.

The head is a round disk and the shank is a cylindrical rod.

The present invention provides a method for connecting the connection part to the rail, wherein the rail and the connection part are made of metal. The connection part includes a head, a shank and a ridge which extends upward and along a top of the head. The ridge encloses a recess defined in the top of the head. The ridge contacts an attaching face of the rail and a portion of the recess faces the attaching face. The ridge of the connection part is welded to the attaching face of the rail, and a portion of the ridge is melted to form a molten area which connects the connection part and the rail when being cooled.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of a rail and a connection part according to a preferred embodiment of the present invention;

FIG. 2 is a cross-sectional view to show that the connection part contacts a lip portion of the rail according to the preferred embodiment of the present invention;

FIG. 3 is a cross-sectional view to show that a molten area is formed at the area where the connection part contacts the lip portion of the rail according to the preferred embodiment of the present invention;

FIG. 4 is a cross-sectional view of the present invention applied to an undermount drawer slide; and

FIG. 5 is a schematic view showing the connection part engaged with a movable device of the undermount drawer slide.

### DETAILED DESCRIPTION OF THE PREFERRED EMBODIMENT

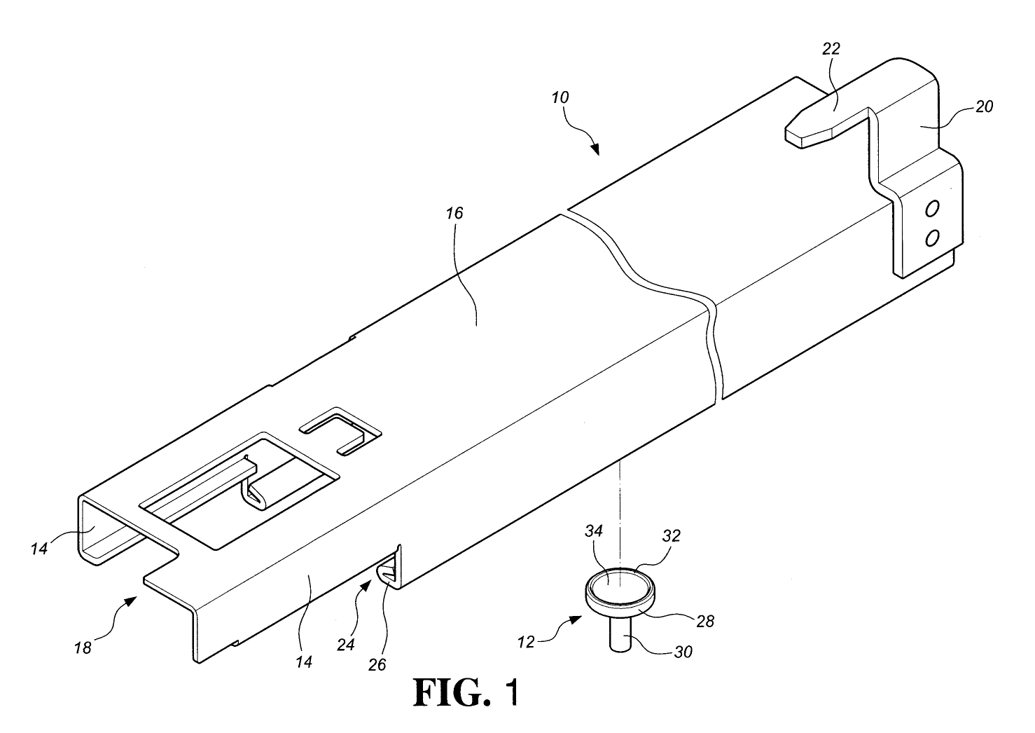

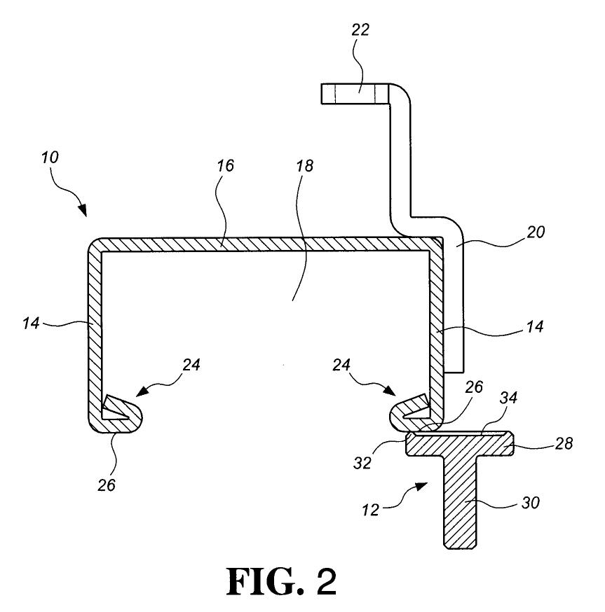

Referring to FIGS. 1 and 2, which show a connection part 12 and a rail 10 of a preferable embodiment of the present invention, wherein the rail 10 and the connection part 12 are made of metal, and the rail 10 includes at least one attaching face to which other part such as the connection part 12 is fixed.

The rail 10 includes a pair of spaced upright walls 14 and a transverse wall 16 connected between two respective top ends of the two upright walls 14. A space 18 is defined between the pair of upright walls 14 and the transverse wall 16. A fixing member 20 is fixed to one of the pair of upright walls 14 and includes an extension 22 which is located above the transverse wall 16. A pair of lip portions 24 extends from two respective lower ends of the pair of upright walls 14 and toward the space 18. Each lip portion 24 includes a substantial planar surface 26 extending from the lower end of the upright wall 14.

The connection part 12 includes a head 28, a shank 30 and a ridge 32 which extends continuously upward and along a top of the head 28. The ridge 32 encloses a recess 34 defined in the top of the head 28. Preferably, the recess 34 is defined and enclosed by the continuous ridge 32. The head 28 is a round disk, and the shank 30 is a cylindrical rod. The attaching face of the rail 10 can be the upright wall 14, the transverse wall 16 or the planar surface 26 of the lip portion 24.

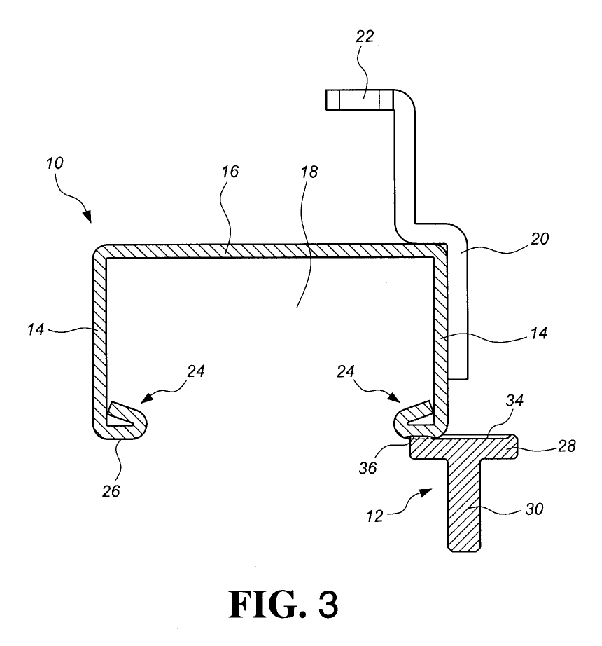

As shown in FIG. 3, when connecting the connection part 12 to the rail 10, the ridge 32 of the connection part 12 is first to contact a predetermined attaching face of the rail 10, such as the planar surface 26 of the rail 10. A portion of the recess 34 faces the attaching face and the ridge 32 of the connection part 12 is welded to the attaching face of the rail 10 by means of spot welding, resistance welding or the like, such that a portion of the ridge 32 which contacts with the attaching face of the rail 10 is melted to form a larger molten area (36) which connects the connection part 12 and the rail 10 when being cooled. By this way, the connection part 12 can be firmly fixed to the rail 10.

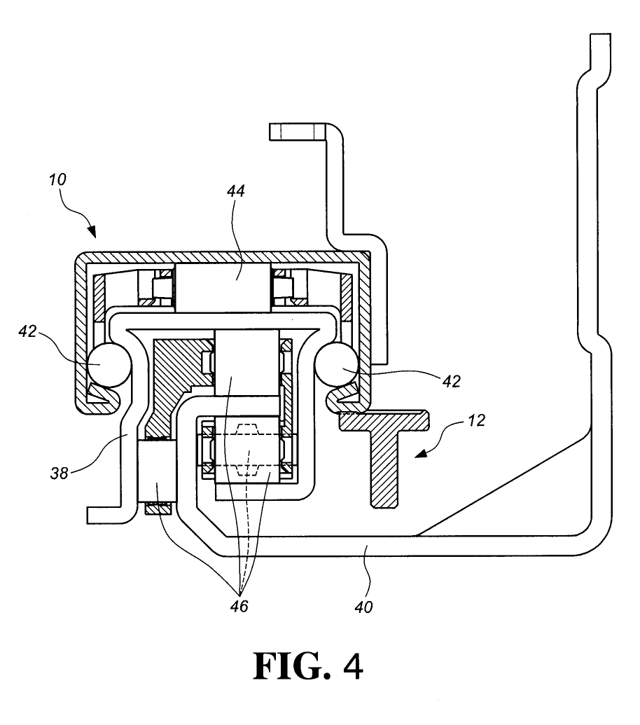

FIG. 4 shows that the rail 10 is cooperated with an undermount drawer slide, wherein a first guide rail 38 is connected to the rail 10 and a second guide rail 40 is connected with the first guide rail 38. At least one first rolling member 42, such as a ball, and at least one second rolling member 44, such as a roller, are respectively located between the rail 10 and the first guide rail 38. At least one third rolling member 46, such as a roller, is located between the first and second guide rails 38, 40. The first guide rail 38 supports the rail 10 and allows the rail 10 to smoothly extend longer distance relative to the second guide rail 40 by the first, second and third rolling members 42, 44, 46.

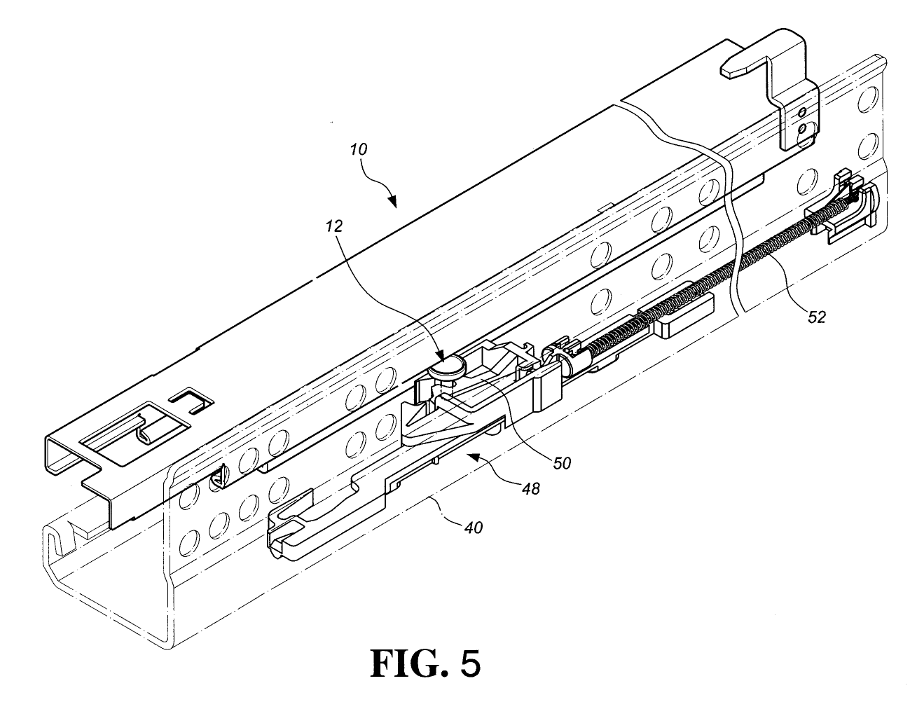

FIG. 5 shows that the rail 10 is cooperated with an undermount drawer slide and a movable device 48 is operated with the drawer slide. The movable device 48 is mounted to the second guide rail 40, and includes a sliding member 50 and a resilient member 52 connected to the sliding member 50. The sliding member 50 is movable by the force of the resilient member 52 so that the connection part 12 drives the rail 10 to move relative to the second guide rail 40.

The connection part 12 and the method provided by the present invention ensure that the connection between the connection part 12 and the rail 10 is reliable and firm. When the rail 10 and the connection part 12 are cooperated with a mechanism including guide rails, the connection part 12 does not break off from the rail 10. The mechanism can be a movable device or the like to automatically return the rail, and the shank 30 of the connection part 12 can be a cylindrical rod. Besides, by the ridge 32 extending continuously along the head 28, the connection part 12 can be welded to the rail 10 by the ridge 32 without being limited to a specific orientation of the connection part 12.

While we have shown and described the embodiment in accordance with the present invention, it should be clear to those skilled in the art that further embodiments may be made without departing from the scope of the present invention.

What is claimed is:

1. A connection part of a rail, comprising:
a head;
a shank extending from an underside of the head, and
a ridge extending continuously from a top of the head and enclosing a recess in the top of the head.

2. The connection part of a rail as claimed in claim 1, wherein the ridge extends along a periphery of the head.

3. The connection part of a rail as claimed in claim 1, wherein the head is a round disk and the shank is a cylindrical rod.

4. A method for connecting a connection part to a rail, the method comprising step of:
providing a metal rail having at least one attaching face;
providing a metal connection part comprising a head, a shank and a ridge which extends continuously upward and along a top of the head, wherein the ridge encloses a recess defined in the top of the head;
placing the ridge to contact the attaching face of the rail and a portion of the recess to face the attaching face, and
welding the ridge of the connection part and the attaching face of the rail so that a portion of the ridge is melted to form a molten area which connects the connection part and the rail when being cooled.

5. The method as claimed in claim 4, wherein the rail includes a pair of spaced upright walls and a transverse wall connected between two respective top ends of the pair of upright walls, a space is defined between the pair of upright walls and the transverse wall, two lip portions extend from two respective lower ends of the pair of upright walls and toward the space, each lip portion includes a planar surface.
